(19) United States
(12) Patent Application Publication
(10) Pub. No.: US 2024/0297417 A1
(43) Pub. Date: Sep. 5, 2024

(54) ELECTRODE ASSEMBLY AND ELECTROCHEMICAL CELL

(71) Applicant: Northvolt AB, Stockholm (SE)

(72) Inventors: Su Jin Yoon, Stockholm (SE); Seungho Kwak, Stockholm (SE); Jeong Keun Kwon, Västerås (SE); Young Kyoung Kim, Stockholm (SE)

(21) Appl. No.: 18/571,867

(22) PCT Filed: Jun. 23, 2022
(86) PCT No.: PCT/EP2022/067201

§ 371 Date: Dec. 19, 2023

(30) Foreign Application Priority Data
Jun. 25, 2021 (EP) 21181692.1

(51) Int. Cl. H01M 50/533; H01M 10/0525; H01M 50/103; H01M 50/443; H01M 50/446; H01M 50/491

(52) U.S. Cl. CPC H01M 50/533; H01M 50/443; H01M 50/446; H01M 50/491; H01M 10/0525; H01M 50/103

(57) ABSTRACT

The present disclosure relates to an electrode assembly comprising a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plate; wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer; and to an electrochemical cell and lithium-ion secondary battery including such an electrode assembly.

### TECHNICAL FIELD

The present disclosure relates to an electrode assembly comprising a positive electrode plate, a negative electrode plate and a separator, to an electrochemical cell and to a lithium-ion secondary battery.

### BACKGROUND

With growing demand in secondary batteries as electrical power supply and energy storage system in portable devices or in electric vehicles, there is also an increasing interest in simplified manufacturing processes and in reducing the costs and the weight of electrochemical cells on the one side, and to ensure safety and performance of the electrochemical cells on the other side.

Known electrochemical cells, or battery cells, or simply “cells” which term are used interchangeably herein, such as lithium-ion secondary batteries, in general include an electrolyte and an electrode assembly immersed in the electrolyte. The electrode assembly includes a stack of positive and negative electrodes, with separator sheets interposed therebetween. The electrolyte acts as a conductor allowing ions to move between the positive electrode (cathode) and the negative electrode (anode) and in the reverse, in an oxidation and reduction reaction, respectively. In lithium-ion secondary batteries (LIBs), lithium ions move from the anode to the cathode during discharge. The separator is usually a thin, porous base or substrate film made of a plastic material, for example polyethylene or polypropylene, which allows movement of ions, prevents a short circuit and provides shutdown functionality in case of thermal runaway. A coating layer comprising an inorganic material may be applied to the base film to improve thermal stability. Furthermore, an electrochemical cell typically comprises a casing for housing the electrodes and the electrolyte, current collectors, terminals and various safety devices. The positive terminal is connected to the positive electrode (cathode) via a positive current collector, whereas the negative terminal is connected to the negative electrode (anode) via a negative current collector. The positive and negative terminals form the electric poles of the electrochemical cell.

As used herein, the term “battery” is intended to encompass an individual battery cell, as well as a battery module, which typically contains a group of electrically connected battery cells, and a battery pack, which typically contains a group of electrically connected battery modules.

The electrodes commonly consist of an aluminum or copper sheet coated with active material. One edge of the sheet is left uncoated to enable connection to a current collector and a cell terminal.

In known electrochemical cells and manufacturing processes thereof, the electrode sheets are notched to create tabs in the uncoated parts before a stacking or winding process, which are then welded to the current collector. Omitting the notching step and using wide tabs instead, which are substantially as wide as the entire cell, is an attractive option, since it reduces manufacturing complexity and thereby costs.

### SUMMARY

During cell assembly, and before the welding has been performed, the electrode and separator sheets may become misaligned if the cell is handled or moved. Such misalignment must be avoided, since it can result in performance and safety problems (e.g. short-circuiting). If the notching step is omitted, however, it is difficult to avoid misalignment of the electrode and separator sheets, since it is difficult to secure the cell assembly in place until welding is completed.

Thus, there is a need for a cell design which overcomes the above-mentioned drawbacks but nevertheless can be manufactured by a simplified process and at reduced costs.

In view of the above-outline requirements, an object of the present invention is to provide an electrode assembly, an electrochemical cell and a lithium-ion secondary battery, which can be manufactured by a simplified process and at reduced costs.

Furthermore, it is an object of the present invention to provide an electrode assembly, an electrochemical cell and a lithium-ion secondary battery, which can ensure stability in manufacturing, thereby facilitating the manufacturing process.

Furthermore, it is an object of the present invention to provide an electrode assembly, an electrochemical cell and a lithium-ion secondary battery, which has improved thermal stability and safety and can ensure high cell or battery performance.

Furthermore, it is an object of the present invention to provide an electrochemical cell and a lithium-ion secondary battery having reduced weight.

One or more of these objects may be solved by an electrode assembly, an electrochemical cell and a lithium-ion secondary battery according to the independent claims. The independent claims and the claims depending therefrom can be combined in any technologically suitable and sensible way, thereby providing preferred embodiments of the invention.

Disclosed herein is an electrode assembly comprising: a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plate; wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer.

In a preferred embodiment, the positive electrode non-coating portion and the negative electrode non-coating portion each have a length in a width direction of the electrode assembly that corresponds to the width of the electrode assembly.

In one embodiment, the positive electrode non-coating portion and the negative electrode non-coating portion each have a length in a width direction of the electrode assembly that does not correspond to the width of the electrode assembly, i.e. the positive electrode non-coating portion and the negative electrode non-coating portion each have a length that is shorter than the width of the electrode assembly.

In a preferred embodiment, the positive electrode non-coating portion and the negative electrode non-coating portion are exposed from opposite sides of the electrode assembly, respectively.

The electrode assembly may include a structure in which the positive electrode plate, the separator, and the negative electrode plate are stacked.

In a preferred embodiment, the organic particles comprise at least one selected from the group consisting of polystyrenes, poly(vinyl alcohol), polyacrylic acid, polyacrylamides and polyacrylates, wherein polyacrylates are preferred, and polymethyl methacrylate (PMMA) is particularly preferred.

In a preferred embodiment, the organic particles have a particle diameter that is 2 to 30 times the particle diameter of the inorganic particles.

In a preferred embodiment, the inorganic particles comprise at least one selected from the group consisting of boehmite, Al₂O₃, Al(OH)₃, Al(NO₃)₃, BN, BaSO₄, MgO, SiO₂, TiO₂, BaTiO₃ and ceramic particles.

In a preferred embodiment, the separator has a thermal shrinkage (%) of about 5% or less at a temperature of 150° C.

In a preferred embodiment, a coverage area of the organic particles on a surface of the coating layer is in the range of 1.5% to 5% with respect to a total surface area of the coating layer.

In a preferred embodiment, the positive electrode active material is selected from a lithium transition metal composite oxide including nickel (Ni), cobalt (Co) and manganese (Mn) as transition metals, wherein the content of nickel is at least 83 mol % based on all transition metals.

Further disclosed herein is an electrochemical cell, comprising an electrode assembly comprising a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plates, wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer.

In a preferred embodiment, the positive electrode non-coating portion and the negative electrode non-coating portion each have a length in a width direction of the electrode assembly that corresponds to the width of the electrode assembly.

In one embodiment, the positive electrode non-coating portion and the negative electrode non-coating portion each have a length in a width direction of the electrode assembly that does not correspond to the width of the electrode assembly, i.e. the positive electrode non-coating portion and the negative electrode non-coating portion each have a length that is shorter than the width of the electrode assembly.

The electrochemical cell may further comprise a positive current collector electrically connected to the positive electrode non-coating portion at a connection region of the positive electrode non-coating portion; and a negative current collector electrically connected to the negative electrode non-coating portion at a connection region of the negative electrode non-coating portion, wherein the connection regions of the positive and the negative electrode non-coating portion each have a length in a width direction of the electrode assembly that corresponds to 70% or less of the length of the positive and negative electrode non-coating portions, respectively.

In a preferred embodiment, a length of the positive current collector and a length of the negative current collector correspond to the length of the connection region of the positive and the negative electrode non-coating portion, respectively.

In a preferred embodiment, the connecting regions of the positive electrode non-coating portion and the negative electrode non-coating portion are in a plane parallel to a stacking plane of the positive and the negative electrode plates in the cell.

The electrochemical cell may be a lithium ion secondary battery.

In a preferred embodiment, the electrochemical cell is of a prismatic-type cell.

Further disclosed herein is a lithium-ion secondary battery, comprising an electrode assembly comprising a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plates, wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer, and wherein the positive electrode active material is selected from lithium transition metal composite oxides including nickel (Ni), cobalt (Co) and manganese (Mn) as transition metals.

In a preferred embodiment, the positive electrode non-coating portion and the negative electrode non-coating portion each have a length in a width direction of the electrode assembly that corresponds to the width of the electrode assembly.

In one embodiment, the positive electrode non-coating portion and the negative electrode non-coating portion each have a length in a width direction of the electrode assembly that does not correspond to the width of the electrode assembly, i.e. the positive electrode non-coating portion and the negative electrode non-coating portion each have a length that is shorter than the width of the electrode assembly.

In a preferred embodiment of the lithium-ion secondary battery, the content of nickel in the lithium transition metal composite oxide is at least 83 mol % based on all transition metals.

### BRIEF DESCRIPTION OF THE DRAWINGS

Different aspects are now described with reference to the accompanying drawings. Apparently, the accompanying drawings in the following description show merely some embodiments of this application, and a person of ordinary skill in the art may still derive other embodiments from these accompanying drawings without creative efforts.

FIG. 1 is a top-down view of an electrode plate that may be used in accordance with an example embodiment of the present disclosure.

FIG. 2 is a top-down view of an electrode assembly according to an example embodiment of the present disclosure.

FIG. 3 is a scanning electron microscope (SEM) image of a surface of a separator that may be used in accordance with an example embodiment of the present disclosure.

### DETAILED DESCRIPTION

The technical solutions of the embodiments of this application will be described in more detail below. It is obvious that the embodiments to be described are a part rather than all of the embodiments of this application. The features of various embodiments can be combined to form further example aspects of the present disclosure that may not be explicitly described or illustrated. All other embodiments obtained by persons of ordinary skill in the art based on the embodiments of the present invention without making creative efforts shall fall within the protection scope of the present disclosure.

When in the following directions like “up”, “down”, “left”, “right”, “width direction” and longitudinal direction” are used, they always refer to the respective Figure referenced.

An electrode assembly according to an embodiment of the present disclosure comprises a positive electrode plate, which may function as a cathode of an electrochemical cell, a negative electrode plate, which may function as an anode of an electrochemical cell, and a separator interposed between the positive and the negative electrode plates. The electrode assembly may be formed by winding or stacking the positive electrode plate, the separator, and the negative electrode plate, which have a foil, film or sheet shape, such that a positive electrode/separator/negative electrode wound structure or stacking structure results.

The positive electrode plate is formed by applying a positive electrode active material, such as a transition metal oxide or a lithiated metal oxide, on a first electrode substrate, which is preferably a metal foil substrate formed of an electrically-conductive material such as aluminum. However, in embodiments of the positive electrode plate according to the present disclosure, the materials for forming the positive electrode plate are not limited to the above-mentioned materials, but rather may include any other suitable materials. The positive electrode plate includes a positive electrode non-coating portion on which the first electrode active material is not applied. The positive electrode non-coating portion functions as a current flow path between the positive electrode plate and the outside of the positive electrode plate. Accordingly, the positive electrode plate according to the present disclosure comprises a positive electrode coating portion having a predetermined area, on which a positive electrode active material is coated, and a positive electrode non-coating portion on which the positive electrode active material is not coated, i.e., a portion that is not coated with the positive electrode active material in a region for connecting a positive current collector.

The negative electrode plate is formed by applying a negative electrode active material, such as carbon, graphite or silicon, or mixtures thereof, on at least one surface of a second electrode substrate, which is preferably a metal foil substrate formed of a second electrically-conductive material such as copper or copper-clad aluminum. However, in embodiments of the negative electrode plate according to the present disclosure, the materials for forming the negative electrode plate are not limited to the above-mentioned materials, but rather may include any other suitable materials. The negative electrode plate includes a negative electrode non-coating portion on which the negative electrode active material is not applied. The negative electrode non-coating portion functions as a path for a current between the negative electrode plate and the outside of the negative electrode plate. Accordingly, the negative electrode plate according to the present disclosure comprises a negative electrode coating portion having a predetermined area, on which a negative electrode active material is coated, and a negative electrode non-coating portion on which the negative electrode active material is not coated, i.e., a portion that is not coated with the negative electrode active material in a region for connecting a negative current collector.

The positive electrode non-coating portion according to an embodiment of the present disclosure is disposed in at least one edge portion of the positive electrode plate and may extend along the entire edge length of the at least one edge portion of the positive electrode plate. Preferably, the positive electrode non-coating portion is disposed in exactly one edge portion of the positive electrode plate, such that one edge portion of the positive electrode plate is not coated with the positive electrode active material over the entire edge length.

According to another embodiment, the positive electrode non-coating portion is disposed in at least one edge portion of the positive electrode plate and extends along part of the edge length of the at least one edge portion of the positive electrode plate. Preferably, the positive electrode non-coating portion is disposed in exactly one edge portion of the positive electrode plate, such that one edge portion of the positive electrode plate is not coated with the positive electrode active material over part of the edge length.

The negative electrode non-coating portion according to an embodiment of the present disclosure is disposed in at least one edge portion of the negative electrode plate and may extend along the entire edge length of the at least one edge portion of the negative electrode plate. Preferably, the negative electrode non-coating portion is disposed in exactly one edge portion of the negative electrode plate, such that one edge portion of the negative electrode plate is not coated with the negative electrode active material over the entire edge length.

According to another embodiment, the negative electrode non-coating portion is disposed in at least one edge portion of the negative electrode plate and extends along part of the edge length of the at least one edge portion of the negative electrode plate. Preferably, the negative electrode non-coating portion is disposed in exactly one edge portion of the positive electrode plate, such that one edge portion of the negative electrode plate is not coated with the negative electrode active material over part of the edge length.

FIG. 1 is a top-down view of an electrode plate having a rectangular shape in accordance with an example embodiment of the present disclosure, in which one edge portion of electrode plate 10 is not coated with electrode active material over the entire edge length. Electrode plate 10 may be a positive or a negative electrode plate. As shown in FIG. 1, electrode plate 10 includes a portion 12 on which an electrode active material is applied, and a non-coating portion 11, on which the electrode active material is not applied. In this case, the non-coating portion 11 is disposed in one edge portion of the electrode plate 10 and extends perpendicular to the longitudinal direction (i.e. direction X in FIG. 1) of the electrode plate 10, such that one side edge portion in the width direction of electrode plate 10 (i.e. in direction Y in FIG. 1) is not coated with electrode active material. However, the present disclosure is not limited thereto, and in embodiments of the electrode plate of the present disclosure not shown in FIG. 1, one edge portion in the longitudinal direction of electrode plate 10 (i.e. in direction X in FIG. 1) may not be coated with electrode active material. As further shown in FIG. 1, the non-coating portion 11 extends to a determined width S1 from the side edge portion in the longitudinal direction of the electrode plate. The width S1 of portion 11 not coated with electrode active material is not particularly limited and can be selected as desired. The length W1 of the non-coating portion 11 in the width direction of the electrode plate 10 (i.e. along direction Y in FIG. 1) perpendicular to the longitudinal direction corresponds to the width W2 of the electrode plate 10, such that the non-coating portion 11 extends over the whole width W2 of the electrode plate 10.

In the electrode assembly according to an embodiment of the present disclosure, the positive electrode non-coating portion and the negative electrode non-coating portion each have a length in a width direction of the electrode assembly that corresponds to the width of the electrode assembly. This means, in other words, that the positive electrode non-coating portion and the negative electrode non-coating portion each extend over the whole width of the electrode assembly.

According to another embodiment, the positive electrode non-coating portion and the negative electrode non-coating portion each have a length in a width direction of the electrode assembly that does not correspond to the width of the electrode assembly, i.e. the positive electrode non-coating portion and the negative electrode non-coating portion each have a length that is shorter than the width of the electrode assembly.

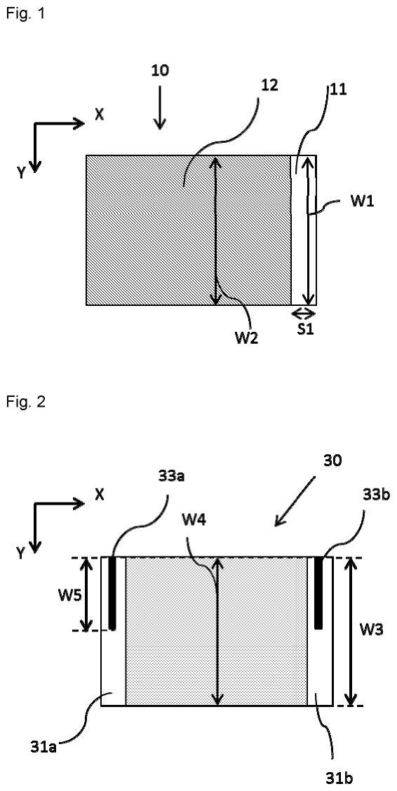

FIG. 2 is a top-down view of an electrode assembly 30 according to an example embodiment of the electrode assembly of the present disclosure. The electrode assembly can include one or more positive electrode plates and one or more negative electrode plates configured as described above, for example with reference to FIG. 1, and a separator disposed therebetween, and may have a wound or stacking structure (not illustrated in FIG. 2). As shown in FIG. 2, the positive and negative electrode non-coating portions 31a and 31b are exposed from opposite sides of the electrode assembly in the longitudinal direction (i.e. in direction X in FIG. 2) of the electrode assembly. The length W3 of the positive and the negative electrode non-coating portions 31a and 31b in a width direction of the electrode assembly 30 (i.e. in direction Y in FIG. 2), perpendicular to the longitudinal direction X, according to this embodiment, corresponds to the width W4 of the electrode assembly 30. Therefore, the positive electrode non-coating portion 31a and the negative electrode non-coating portion 31b each extend over the whole width W4 of the electrode assembly 30.

This configuration of the electrode assembly allows omitting the notching of the non-coating portions of the electrode plates in a manufacturing process thereof, which is commonly performed to create tabs in the non-coating portions. Not performing the notching step reduces manufacturing complexity of the electrode assembly and facilitates a cell fabrication process, thereby reducing manufacturing costs.

According to a preferred embodiment, as shown in FIG. 2, the positive electrode non-coating portion and the negative electrode non-coating portion are exposed from opposite sides of the electrode assembly.

According to a further preferred embodiment of the electrode assembly, in which the positive and negative electrode non-coating portions are exposed from opposite sides of the electrode assembly, a plurality of positive electrode plates each having a positive electrode non-coating portion and a plurality of negative electrode plates each having a negative electrode non-coating portion, configured as described above for example with reference to FIG. 1, are stacked alternately with an intervening separator disposed between each positive electrode and each negative electrode. The positive electrode plates and the negative electrode plates are laterally offset, so that the positive electrode non-coating portions extend from one side of the electrode stack constituting the electrode assembly and the negative electrode non-coating portions extend from an opposite side of the electrode stack constituting the electrode assembly. The separator may be folded in a zigzag manner by being bent 180 degrees and inserted in zigzag in a lateral direction of the positive and the negative electrode plates when the positive and the negative electrode plates are alternately stacked.

As mentioned above, however, the electrode assembly is not particularly limited as long as it has a structure that connects one or more positive electrode plates and one or more negative electrode plates to form an anode and a cathode of an electrochemical cell, and may include a wound structure or a stacked structure.

According to a preferred embodiment, the electrode assembly includes a structure in which the positive electrode plate, the separator, and the negative electrode plate are stacked, that is, a positive electrode/separator/negative electrode stacking structure resulting from stacking the positive electrode plate and the negative electrode plate with an intervening separator therebetween.

The separator is disposed between the positive electrode plate and the negative electrode plate to prevent a short circuit and to allow movement of ions. The separator according to this embodiment of the present disclosure is a separator comprising a porous substrate and a coating layer disposed on at least one surface of the substrate, which includes organic particles and inorganic particles. The porous substrate may be a film formed of a resin, for example, polyolefin such as polyethylene, polypropylene, a mixture thereof, or a copolymer thereof, but embodiments are not limited thereto, and the porous substrate may be any porous film available in the art. In embodiments of the separator, a thickness of the porous substrate may be in a range of about 3 μm to about 20 μm, and/or a porosity of the porous substrate may be in a range of about 30% to about 50%.

The coating layer includes the organic particles and the inorganic particles as a mixture, that is, the organic particles and the inorganic particles are mixed together in the coating layer, and are not provided in independent separate layers. The organic particles may function as an electrode adhesive that enhances the adhesive force between the separator and an electrode plate.

According to this embodiment of the electrode assembly of the present disclosure, an amount of the organic particles in the coating layer is in the range from 1.5 to 5 wt. % related to a total weight of the organic particles and the inorganic particles in the coating layer.

Within this low amount of organic particles in relation to the inorganic particles, a shrinkage rate of the separator can be reduced and separator thermal stability can be improved, which results in improved separator properties and safety of an electrochemical cell, and at the same time a strong enough adhesion between the separator and the electrode plates can be achieved, such that the risk of separator misalignment during manufacturing of the electrode assembly in a cell manufacturing process is reduced, which allows to facilitate the manufacturing process and to improve the performance and safety of the cell. An amount of more than 5 wt. % of organic particles related to a total weight of the organic particles and the inorganic particles in the coating layer could prevent ion flow (e.g. Li-ion flow) and increase cell impedance. If the amount of the organic particles is less than 1.5 wt. %, sufficient adhesive force may not be achieved.

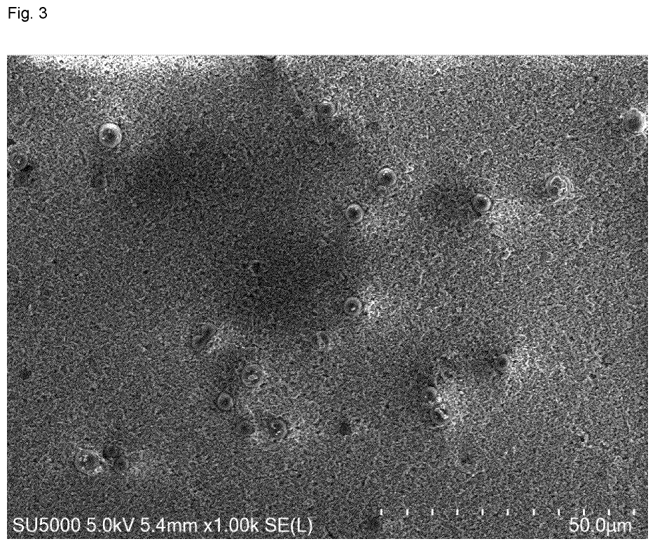

FIG. 3 shows an SEM image of a surface of the separator, in which the proportion boehmite inorganic particles: organic particles in the coating layer is 97.5 wt %: 3.5 wt. %.

With reference to FIG. 3, the organic particles may protrude as an embossed structure from the surface of the porous coating layer to thereby act as an electrode adhesive, and may be distributed on the surface of the coating layer, that is, the surface of the inorganic layer opposite to a bottom surface in contact with the porous substrate, thereby covering a portion of the surface area of the coating layer. In a preferred embodiment, a coverage area ratio of the organic particles on the surface of the coating layer is in the range of 1.5% to 5% with respect to a total surface area of the coating layer (i.e., the total surface area of the surface of the inorganic layer opposite to the bottom surface in contact with the porous substrate). If the organic particle coverage area is more than 5%, a higher adhesion force of the separator may be achieved, but the performance of the separator may be hindered due to a resistance increment by the organic particles, which may prevent ion flow (e.g. Li-ion flow). If the organic particle coverage area is less than 1.5%, sufficient adhesion strength between the separator and the electrodes may not be achieved.

In a preferred embodiment, the separator has a thermal shrinkage (%) of about 5% or less at a temperature of 150° C., which is advantageous in terms of performance and safety of the electrochemical cell. For example, a thermal shrinkage (%) of the separator may be about 5% or less at a temperature of 150° C. in both the machine direction (MD) and the transverse direction (TD). More preferably, a thermal shrinkage (%) of the separator at a temperature of 150° C. is from 0% (i.e., no shrinkage) or more to less than 5%, even more preferably from 0% or more to less than 3% in both the MD and TD. When the thermal shrinkage (%) of the separator is within these ranges, thermal shrinkage characteristics of the separator can be suppressed, and thus rate characteristics and lifetime characteristics of the electrochemical cell can be improved. The thermal shrinkage (%) of the separator according to the present disclosure is measured by the following method: A sample of 100 mm×100 mm is put into an oven with a constant temperature of 150° C. After 1 hour of isothermal treatment, the sample is cooled to room temperature (about 23° C.). Thermal shrinkage (%) in machine direction (MD) and transverse direction (TD) is each calculated then by the formula: S=100*(L1−L2)/L1, where S is thermal shrinkage (%), L1 is length before heating (mm), L2 is length after heating (mm).

The inorganic particles may act as a filler, may enable a uniform thin film coating when mixed with the organic particles, may improve the thermal stability of the separator, and may enhance electrolyte wetting due to the hydrophilic surface characteristics.

An average particle diameter (D50) of the inorganic particles is preferably in a range of about 0.01 μm to about 3.0 μm, more preferably about 0.1 to about 1.0 μm. Within this range, a coating layer having a uniform thickness and an appropriate porosity that is higher than the porosity of the porous substrate can be formed, thereby improving cell performance. For example, in some preferred embodiments, the average particle diameter (D50) of the organic particles may be in a range of about 0.3 μm to about 0.8 μm. In other preferred embodiments, the average particle diameter (D50) of the inorganic particles may be in a range of about 0.1 μm to about 0.15 μm, and in particular may be about 0.1 μm.

According to the present disclosure, the average particle diameter (D50) of (inorganic or organic) particles is determined by scanning electron microscopy (SEM) using, for example, a particle size analyzer.

The inorganic particles may be a metal oxide, a metalloid oxide, or a combination thereof. For example, the inorganic particles may be at least one selected from boehmite (AlOOH), alumina (Al₂O₃), aluminum trihydroxide (Al(OH)₃), aluminum nitrate (Al(NO₃)₃), boron nitride (BN), barium sulfate (BaSO₄), magnesium oxide (MgO), silica (SiO₂), titanium dioxid (TiO₂), barium titanate (BaTiO₃) and ceramic particles, without being limited thereto. Therefore, in a further preferred embodiment, the inorganic particles comprise at least one selected from the group consisting of boehmite, Al₂O₃, Al(OH)₃, Al(NO₃)₃, BN, BaSO₄, MgO, SiO₂, TiO₂, BaTiO₃ and ceramic particles.

The inorganic particles may be in sphere, plate, or fiber form, but embodiments are not limited thereto, and the inorganic particles may be in any form available in the art. Boehmite particles, in particular having an aspect ratio in a range of about 1:1 to about 1:10 as determined by scanning electron microscopy (SEM) using, for example, a particle size analyzer, may be particularly preferred, because boehmite is relatively lighter than alumina and therefore can reduce the weight of the cell.

Preferred examples of the organic particles may be selected from polystyrenes, poly(vinyl alcohol) (PVA), polyacrylic acid (PAA), polyacrylamides, and polyacrylates, such as polymethyl methacrylate (PMMA), and derivatives and copolymers thereof, but embodiments are not limited thereto. Therefore, in a further preferred embodiment, the organic particles comprise at least one selected from the group consisting of polystyrenes, poly(vinyl alcohol), polyacrylic acid, polyacrylamides and polyacrylates. Particularly preferably, the organic particles are made from polyacrylates. Preferred examples include polymethyl (meth)acrylate, polyethyl (meth)acrylate, poly n-propyl (meth)acrylate, poly isopropyl (meth)acrylate, poly n-butyl (meth)acrylate, poly t-butyl (meth)acrylate, poly sec-butyl (meth)acrylate, polypentyl (meth)acrylate, poly 2-ethylbutyl (meth)acrylate, poly 2-ethylhexyl (meth)acrylate, poly n-octyl (meth)acrylate, polyisooctyl (meth)acrylate, polyisononyl (meth)acrylate, poly lauryl (meth)acrylate, poly tetradecyl (meth)acrylate, without being limited thereto, of which polymethyl methacrylate (PMMA) is particularly preferred.

In a further preferred embodiment, the organic particles have a particle diameter that is 2 to 30 times the particle diameter of the inorganic particles. By this, it is ensured that the organic particles protrude at least to a predetermined height from a surface of the porous coating layer to thereby act as the electrode adhesive, as indicated in FIG. 3. That is, during manufacturing of the electrode assembly, when the electrode plates are pressed against the separator, the relatively larger organic particles will be compressed, thereby effectively forming an adhesive coating. When the organic particles have a particle diameter smaller than 2 times of that of the inorganic particles, the organic particles may not protrude from the surrounding surface of the coating layer in a sufficient manner to enable adhesion to the electrode plates. Also, when their particle diameter is greater than 30 times that of the inorganic particles, an adhesion area between the electrode plates and the separator increases, which may increase resistance of the electrochemical cell. For example, in some preferred embodiments, the organic particles have a particle diameter of 2 to 15 times of the particle diameter of the inorganic particles. In other preferred embodiments, the organic particles have a particle diameter of 10 to 20 times of the particle diameter of the inorganic particles.

Notwithstanding the above, it is however preferable that an average particle diameter (D50) of the organic particles is in a range of about 1.5 μm to about 5.0 μm. For example, in some preferred embodiments, the average particle diameter (D50) of the organic particles may be in a range of about 3.0 μm to about 5.0 μm. In other preferred embodiments, the average particle diameter (D50) of the organic particles may be in a range of about 1.5 μm to about 2.0 μm.

The coating layer may be disposed on one surface or on both surfaces of the substrate, but preferably is disposed on both surfaces of the substrate. The coating layers positioned on both surfaces of the separator preferably have the same composition in order to ensure that the same adhesive force is applied to the corresponding electrode plates on both surfaces of the separator, such that ions, such as Li-ions in case of a lithium-ion secondary battery, can uniformly pass to both positive and negative electrode sides.

A thickness of a single coating layer in the electrode assembly (i.e. after compressing of the electrode plates and the separator including the organic and inorganic particles in the coating layer) may be in a range of about 0.5 μm to about 5.0 μm. For example, in some preferred embodiments, the thickness of a single coating layer may be in a range of about 1.0 μm to about 4.0 μm. In other preferred embodiments, the thickness of a single coating layer may be in a range of about 0.5 μm to about 1.0 μm. When a thickness of the (single) coating layer is within this range, the separator including the coating layer(s) may provide good adhesion to the electrode plates and good heat resistance and insulating properties. That is, when the amount of the organic particles in the coating layer and preferably also the average particle sizes of the organic and the inorganic particles are within the predetermined ranges described above, the coating layer of the separator according to embodiments of the present disclosure may have good adhesion to the electrode plates and good binding strength to the substrate, and the separator may have good thermal stability and reduced shrinkage rate.

In some embodiments, the coating layer may further comprise polymer particles, which preferably have a smaller average particle diameter than the organic particles and may function as another binder. That is, the binder polymer particles may be mixed together with the organic particles and the inorganic particles in the coating layer in order to enhance binding between the inorganic particles and the substrate and to improve durability of the coating layer. An average particle diameter (D50) of the binder polymer particles may be in a range of about 0.05 μm to about 0.3 μm. When an average particle diameter of the binder polymer particles is within this range, efficient binding between the inorganic particles and the substrate can be ensured. The glass transition temperature (Tg) of the binder polymer particles may be in a range of about −20° C. to 20° C. Preferred examples of the binder polymer particles include styrene-butadiene rubber (SBR) and polyacrylates. The glass transition temperature is determined according to the present disclosure by differential scanning calorimetry (DSC) in a temperature range of −40° C.˜100° C. and setting up the ramping temperature conditions at 10° C./min.

In some embodiments, the coating layer may further comprise a polymer compound, which is thermally stable and may function as another binder.

Preferred examples of the thermally stable binder polymer include, without being limited thereto, carboxyl methyl cellulose (CMC), poly(vinly alcohol) (PVA), polyvinylpryrrolidone (PVP), polyvinlyacetamide (PVAc), polyacylonitrile (PAN), polyacrylic acid (PAA), polymaleic anhydride, and polyacrylamides, including derivatives and copolymers thereof.

Preferred example of polyacrylamides include N-(butoxymethyl)(meth)acryloamide, N-tert-butyl(meth)acrylamide, di-acetone(meth)acrylamide, N,N-dimethyl(meth)acrylamide, N-(isobutoxymethyl)acrylamide, N-(isopropyl)(meth)acrylamide, (meth)acrylamide, N-phenyl(Meth)acrylamide, N-(tris(hydroxymethyl)methyl)(meth)acrylamide, N—N′-(1,2-dihydroxyethylene)bisacrylamide, N—N′-(1,2-Dihydroxyethylene) bisacrylamide, N—N′-ethylene bis (meth) acrylamide, and mixtures thereof, without being limited thereto.

Preferably, the ratio of the total amount of organic particles, binder polymer particle and thermally stable binder polymer to the total amount of inorganic particles in the coating layer is in the range of 1:10 to 1:25.

The electrode assembly according to this embodiment of the present disclosure, which combines wide non-coating portions that extend over the whole width of the electrode assembly with a separator having an adhesive function with a relatively low amount of organic particles, provides the combined advantages that it is simple and cost-effective to manufacture, as the notching step can be omitted the risk of separator misalignment can be reduced, and also has improved thermal stability and safety when used in an cell or battery.

Although the notching step may be omitted according to a preferred embodiment of the present invention, it should be understood that the present invention also relates to embodiments comprising the notching step.

The electrode assembly according to this embodiment of the present disclosure further provides the advantage that the low content of organic particles present in the coating layer in relation to the inorganic particles (i.e. in the range from 1.5 to 5 wt. % related to a total weight of the organic particles and the inorganic particles in the coating layer), contributes to increased porosity and electrolyte soaking property of the coating layer, and thereby ensures that the cell performance stays high even in the presence of gas. This provides the further advantage that lithium transition metal composite oxides having a high nickel content, for example a nickel content of 83 mol % or more based on all transition metals, which may lead to gas generation in an electrochemical cell during operation, can be used as the active material in the electrode assembly according to this embodiment of the present disclosure. At the same time, adhesion of the separator to the electrode plates by the organic particles can prevent gas trap during the cycle life, which could make the cell deteriorate faster, and due to the functionality of adhesion between separator and electrode plates the surface of the electrodes may have a uniform potential, which can secure a long-term cycle life.

Thus, according to a further preferred embodiment of the electrode assembly, the positive electrode active material is a lithium transition metal composite oxide, wherein the metal includes one or more of nickel (Ni), cobalt (Co) and manganese (Mn). More preferably, the composite oxide includes nickel, cobalt and manganese (i.e. the positive electrode active material is a lithium nickel cobalt manganese (NCM) oxide), and even more preferably, the content of nickel is at least 83 mol % based on all transition metals nickel, cobalt and manganese. That is, the composite oxide used as the positive electrode active material according to a further preferred embodiment has the general formula: LiNi_{1-x-y}CoₓMn_{y}O₂; with 0<y, 0<x; and x+y≤0.17. Such an active material with high content of nickel is advantageous, because the nickel can ensure that the discharge capacity is high and that the material structure maintains uniform under charging and discharging when used as a positive electrode active material in an electrochemical cell, such as a lithium-ion secondary battery, and can advantageously be used as the positive electrode active material in an electrode assembly described above in accordance with the present disclosure without affecting the safety and performance of a cell, while also taking advantage of the simplified manufacturing process and improved thermal stability.

However, it should be understood that in order to ensure that materials with high content of nickel, such as lithium transition metal composite oxides having a nickel content of 83 mol % or more based on all transition metals, can advantageously be used as electrode active materials in the electrode assembly, it is not necessarily required that the positive and negative electrode plates have the above described wide non-coating portions that extend over the whole width of the electrode assembly.

Therefore, an alternative embodiment of the present disclosure provides for an electrode assembly comprising a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plate; wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer, and wherein a positive electrode active material is selected from a lithium transition metal composite oxide including nickel (Ni), cobalt (Co) and manganese (Mn) as transition metals. Preferably, the content of nickel is at least 83 mol % based on all transition metals.

Preferred embodiments of the separator are configured as described above. In some embodiments, the positive electrode non-coating portion and the negative electrode non-coating portion may each have a length in a width direction of the electrode assembly that corresponds to the width of the electrode assembly as defined above.

The present disclosure further provides for an electrochemical cell comprising an electrode assembly according to embodiments of the present disclosure as described above.

According to an embodiment of the present disclosure, an electrochemical cell comprises a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plates, wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer.

According to an embodiment, the positive electrode non-coating portion and the negative electrode non-coating portion each have a length in a width direction of the electrode assembly that corresponds to the width of the electrode assembly.

According to one embodiment, the positive electrode non-coating portion and the negative electrode non-coating portion each have a length in a width direction of the electrode assembly that does not correspond to the width of the electrode assembly, i.e. the positive electrode non-coating portion and the negative electrode non-coating portion each have a length that is shorter than the width of the electrode assembly.

Preferred embodiments of the separator are configured as described above.

According to a preferred embodiment, the electrochemical cell of the present disclosure further comprises a positive current collector electrically connected to the positive electrode non-coating portion, and a negative current collector electrically connected to the negative electrode non-coating portion. According to this embodiment, the positive and the negative electrode non-coating portion each include a connection region, at which the positive current collector and the negative current collector are connected, respectively. As illustrated in FIG. 2, in which an example electrode assembly in accordance with the present disclosure is shown, positive electrode non-coating portion 31a has a connection region 33a, and negative electrode non-coating portion 31b has a connection region 33b, and both connection regions 33a and 33b have one edge located in close proximity to an edge of the electrode assembly (i.e. the upper edge in FIG. 2). Each of connection regions 33a and 33b extends at a length W5 in a width direction of the electrode assembly 30 (i.e. in direction Y in FIG. 2) perpendicular to the longitudinal direction X corresponding to about 50% of the length W3 of the positive or the negative electrode non-coating portion 31a and 31b. However, FIG. 2 merely shows an example, non-limiting embodiment, and the connection regions of the positive and the negative electrode non-coating portion may each have a length in a width direction of the electrode assembly (W5) that corresponds to 70% or less of the length of the positive or the negative electrode non-coating portion (W3). For example, in some preferred embodiments, the length (W5) of each connection region of the positive and the negative electrode non-coating portion may be in a range of 50% to 70% of the length of the positive or the negative electrode non-coating portion (W3). In other preferred embodiments, the length (W5) of each connection region of the positive and the negative electrode non-coating portion may be 50% or less of the length of the positive or the negative electrode non-coating portion (W3), for example, 40% or less, but preferably 30% or more of length W3. However, in some embodiments the length (W5) of a connection region could even be smaller if the connection region is made wider instead, so that the connection region overall has the same area.

According to preferred embodiments not shown in FIG. 2, the connection region of the positive electrode non-coating portion and the connection region of the negative electrode non-coating portion may have different lengths.

Further, according to preferred embodiments not shown in FIG. 2, the connection regions of the positive and the negative electrode non-coating portion not necessarily have to be located in close proximity to an edge (for example, the upper edge in FIG. 2) of the electrode assembly, but may be located in between opposite edges of the electrode assembly. This means with reference to FIG. 2 that connection regions 33a and 33b not necessarily have to extend in a width direction of the electrode assembly 30 starting from the upper edge and extending towards the lower edge (or vice versa), but one or both connection regions 33a and 33b are located somewhere in between the upper and the lower edge of the electrode assembly and extend at a length W5 in a width direction of the electrode assembly 30. For example, connection regions 33a and 33b may be located such that a distance between an upper edge of connection regions 33a and 33b and the upper edge of the electrode assembly 30 is shorter than a distance between a lower edge (opposite to the upper edge) of connection regions 33a and 33b and the lower edge of the electrode assembly 30, or vice versa.

Further, according to preferred embodiments not shown in FIG. 2, one of the connection regions of the positive and the negative electrode non-coating portion may be located in proximity to one edge (for example the upper edge in FIG. 2) of the electrode assembly, and the other connection region may be located in proximity to the opposite edge (i.e., the lower edge in FIG. 2) of the electrode assembly.

The positive and the negative current collector may be formed of aluminum or an aluminum alloy, or copper or a copper alloy. However, the material of the positive and the negative current collector is not limited thereto and, in other embodiments, the positive and the negative current may be formed of any other suitable material.

The positive and the negative current collector may be connected to the positive and the negative electrode non-coating portion, respectively, by welding.

That is, the connection region of the positive electrode non-coating portion is welded to the positive current collector and the connection region of the negative electrode non-coating portion is welded to the negative current collector, and the welds each have a length corresponding to 70% or less, for example, in the range of 50% to 70%, or 50% or less, or 40% or less, but preferably 30% or more, of the length of the positive or the negative electrode non-coating portion in a direction perpendicular to the longitudinal direction of the electrode assembly. Since the welds have a relatively short length in relation to the non-coating portions (i.e. 70% or less), welding time is shortened and manufacturing complexity of the electrochemical cell is reduced.

In addition, this configuration of the electrochemical cell allows omitting the notching of the non-coating portions of the electrode plates, which further reduces manufacturing complexity of the electrochemical cell and facilitates the cell fabrication process, thereby reducing manufacturing costs.

Although the notching step may be omitted according to a preferred embodiment of the present invention, it should be understood that the present invention also relates to embodiments comprising the notching step.

The connecting regions of the positive electrode non-coating portion and the negative electrode non-coating portion may be in a plane parallel to a stacking plane of the positive and the negative electrode plates in the electrode assembly (that is, parallel to a plane determined by the X- and Y-directions in FIG. 2). That is, the positive and the negative current collector may be connected or welded to the connecting regions of the positive and the negative electrode non-coating portion in a plane parallel to the stacking plane of the positive and the negative electrode plates in the electrode assembly.

In a further preferred embodiment of the electrochemical cell, a length of the positive current collector corresponds to the length of the connection region of the positive electrode non-coating portion or the length of the respective weld in case the positive current collector is connected by welding; and a length of the negative collector corresponds to the length of the connection region of the negative electrode non-coating portion or the length of the respective weld in case the negative current collector is connected by welding. By this, the length of the positive and the negative current collector is kept short in relation to the non-coating portions, i.e. 70% or less, for example, in the range of 50% to 70%, or 50% or less, or 40% or less, but preferably 30% or more, of the length of the non-coating portions, as described above. This configuration saves material and reduces the weight of the cell, while taking advantage of the facilitated manufacturing process described above.

According to a further preferred embodiment, the positive and the negative current collector each include a first and a second connection portion. The first connection portions of the positive and the negative current collector are configured to be connected to a positive and a negative electrode terminal, respectively. The second connection portions of the positive and the negative current collector are configured to be connected, preferably by welding, to the connection region of the positive and the negative electrode non-coating portion, respectively. According to this further preferred embodiment, a length of each of the second connection portions corresponds to the length of the respective connection region or weld at the positive and the negative electrode non-coating portion, in order to save material and reduce the weight of the cell.

In an example embodiment, the positive and the negative current collector each may have a generally reverse L-shape including the first and the second connection portions being arranged substantially at a right angle.

Since the electrochemical cell according to this embodiment of the present disclosure comprises the separator configured as described above, which has an adhesive function with a relatively low amount of organic particles (i.e., in the range from 1.5 to 5 wt. % related to a total weight of the organic particles and the inorganic particles in the coating layer), improved thermal stability and safety of the electrochemical cell can additionally be achieved.

However, it should be understood that in order to ensure a simplified manufacturing process without increasing cost and weight of the cell, it is not necessarily required that the separator is configured as described above.

Therefore, according to an another embodiment of the present disclosure, an electrochemical cell comprises a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plates.

In a preferred embodiment, the positive electrode non-coating portion and the negative electrode non-coating portion each have a length in a width direction of the electrode assembly that corresponds to the width of the electrode assembly.

In one embodiment, the positive electrode non-coating portion and the negative electrode non-coating portion each have a length in a width direction of the electrode assembly that does not correspond to the width of the electrode assembly, i.e. the positive electrode non-coating portion and the negative electrode non-coating portion each have a length that is shorter than the width of the electrode assembly.

Preferably according to this embodiment, the electrochemical cell further comprises a positive current collector electrically connected to the positive electrode non-coating portion at a connection region or weld of the positive electrode non-coating portion; and a negative current collector electrically connected to the negative electrode non-coating portion at a connection region or weld of the negative electrode non-coating portion, wherein the connection regions or welds each have a length corresponding to 70% or less of the length of the positive or the negative electrode non-coating portion in a direction perpendicular to the longitudinal direction of the electrode assembly, and wherein the length of the positive current collector and the length of the negative current collector corresponds to the length of the respective connection portion or weld (i.e., 70% or less of the length of the non-coating portions), as described above.

Further preferred embodiments of the positive and the negative current collector, and of the respective connection regions or welds, are configured as described above. In some embodiments, the separator may be configured as described above.

A typical example of an electrochemical cell is a secondary battery. Preferably, the secondary battery is a lithium-ion secondary battery having lithium ions as a medium.

Based on the form of the electrode assembly and based on the structure or the form of a battery case, an electrochemical cell may be classified as a cylindrical-type cell, a prismatic-type cell or a pouch-shaped cell. The present disclosure is preferably applicable to the prismatic-type cell. Thus, the electrochemical cell according to the embodiments of the present disclosure is preferably a prismatic-type lithium-ion secondary battery.

According to another aspect, the present disclosure provides for a lithium-ion secondary battery comprising an electrode assembly according to embodiments of the present disclosure as described above, and a lithium nickel cobalt manganese composite oxide as the positive electrode active material.

According to an embodiment of the present disclosure, a lithium-ion secondary battery comprises an electrode assembly comprising a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plates, wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer, and wherein the positive electrode active material is selected from lithium transition metal composite oxides including nickel (Ni), cobalt (Co) and manganese (Mn) as transition metals.

In a preferred embodiment, the positive electrode non-coating portion and the negative electrode non-coating portion each have a length in a width direction of the electrode assembly that corresponds to the width of the electrode assembly.

In one embodiment, the positive electrode non-coating portion and the negative electrode non-coating portion each have a length in a width direction of the electrode assembly that does not correspond to the width of the electrode assembly, i.e. the positive electrode non-coating portion and the negative electrode non-coating portion each have a length that is shorter than the width of the electrode assembly.

In a preferred embodiment of the lithium-ion secondary battery, the content of nickel in the lithium transition metal composite oxide is at least 83 mol % based on the total content of nickel, cobalt and manganese. That is, the composite oxide used as the positive electrode active material preferably has the general formula: LiNi_{1-x-y}CoₓMn_{y}O₂; with 0<y, 0<x; and x+y≤0.17. Such a high content of nickel of the positive electrode active material can advantageously ensure that the discharge capacity of the battery is high and that the material structure maintains uniform under charging and discharging conditions. However, such a high level of nickel may lead to excessive gas generation in the battery during operation, and the trapped gas may lead to the formation of voids filled with gas between the separator an the electrodes, which could make the cell deteriorate faster.

However, as the lithium-ion secondary battery according to this embodiment includes the electrode assembly configured as described above, that is, the separator adheres to the electrodes due to the organic particles included in the coating layer, gas trap during the cycle life is prevented, and due to the functionality of adhesion between separator and electrodes the surface of the electrodes may have a uniform potential, which can secure a long-term cycle life. Thus, lithium nickel cobalt manganese oxide having a high content of nickel of at least 83 mol % can advantageously be used as the positive electrode active material of the secondary battery according to this embodiment of the present disclosure.

At the same time, since the content of organic particles present in the coating layer is low in relation to the inorganic particles (i.e. in the range from 1.5 to 5 wt. % related to a total weight of the organic particles and the inorganic particles in the coating layer), thermal stability and shrinkage rate of the separator are only minimally affected, so that high safety and performance of the lithium-ion secondary battery can be ensured.

According to a further preferred embodiment, the lithium-ion secondary battery of the present disclosure further comprises a positive current collector electrically connected to the positive electrode non-coating portion at a connection region of the positive electrode non-coating portion; and a negative current collector electrically connected to the negative electrode non-coating portion at a connection region of the negative electrode non-coating portion, wherein the connection regions of the positive and the negative electrode non-coating portion each have a length in a width direction of the electrode assembly that corresponds to 70% or less of the length of the positive or the negative electrode non-coating portion. For example, in some preferred embodiments of the lithium-ion secondary battery, the length of each connection region of the positive and the negative electrode non-coating portion may be in a range of 50% to 70% of the length of the positive or the negative electrode non-coating portion. In other preferred embodiments of the lithium-ion secondary battery, the length of each connection region of the positive and the negative electrode non-coating portion may be 50% or less, for example, 40% or less, but preferably 30% or more of the length of the positive or the negative electrode non-coating portion. However, in embodiments the length of a connection region could even be smaller if the connection region is made wider instead, so that the connection region overall has the same area.

The positive and the negative current collector may be formed of aluminum or an aluminum alloy, or copper or a copper alloy. However, the material of the positive and the negative current collector is not limited thereto and, in other embodiments, the positive and the negative current may be formed of any other suitable material.

The positive and the negative current collector may be connected to the positive and the negative electrode non-coating portion, respectively, by welding.

That is, the connection region of the positive electrode non-coating portion is welded to the positive current collector and the connection region of the negative electrode non-coating portion is welded to the negative current collector, and the welds each have a length corresponding to 70% or less, for example, in the range of 50% to 70%, or 50% or less, or 40% or less, but preferably 30% or more, of the length of the positive or the negative electrode non-coating portion in a direction perpendicular to the longitudinal direction of the electrode assembly. Since the welds have a relatively short length in relation to the non-coating portions (i.e. 70% or less), welding time is shortened and manufacturing complexity of the lithium-ion secondary battery is reduced.

In addition, this configuration of the lithium-ion secondary battery allows omitting notching of the non-coating portions of the electrode plates, which further reduces manufacturing complexity of the lithium-ion secondary battery and facilitates the battery fabrication process, thereby reducing manufacturing costs.

Although the notching step may be omitted according to a preferred embodiment of the present invention, it should be understood that the present invention also relates to embodiments comprising the notching step.

The connecting regions of the positive electrode non-coating portion and the negative electrode non-coating portion may be in a plane parallel to a stacking plane of the positive and the negative electrode plates in the electrode assembly (that is, parallel to a plane determined by the X- and Y-directions in FIG. 2). That is, the positive and the negative current collector may be connected or welded to the connecting regions of the positive and the negative electrode non-coating portion in a plane parallel to the stacking plane of the positive and the negative electrode plates in the electrode assembly.

In a preferred embodiment of the lithium-ion secondary battery, a length of the positive current collector corresponds to the length of the connection region of the positive electrode non-coating portion or the length of the respective weld in case the positive current collector is connected by welding; and a length of the negative collector corresponds to the length of the connection region of the negative electrode non-coating portion or the length of the respective weld in case the negative current collector is connected by welding. By this, the length of the positive and the negative current collector is kept short in relation to the non-coating portions, i.e. 70% or less, for example, in the range of 50% to 70%, or 50% or less, or 40% or less, but preferably 30% or more, of the length of the non-coating portions, as described above, which saves material and reduces the weight of the lithium-ion secondary battery, while taking advantage of the facilitated manufacturing process described above.

According to a further preferred embodiment, the positive and the negative current collector each include a first and a second connection portion. The first connection portions are configured to be connected to a positive and a negative electrode terminal, respectively. The second connection portions are configured to be connected, preferably by welding, to the connection region of the positive and the negative electrode non-coating portion, respectively. According to this further preferred embodiment, a length of each of the second connection portions corresponds to the length of the respective connection region or weld at the positive and the negative electrode non-coating portion, in order to save material and reduce the weight of the lithium-ion secondary battery.

In an example embodiment, the positive and the negative current collector each may have a generally reverse L-shape including the first and the second connection portions being arranged substantially at a right angle.

However, it should be understood that in order to ensure that a lithium transition metal composite oxide having a high nickel content, such as 83 mol % or more based on all transition metals, can advantageously be used as electrode active materials in the lithium-ion secondary battery, it is not necessarily required that the positive and negative electrode plates have the above described wide non-coating portions that extend over the whole width of the electrode assembly, and that the length of the positive and the negative current collector is kept short in relation to the non-coating portions, as described above.

Therefore, an alternative embodiment of the present disclosure provides for a lithium-ion secondary battery comprises an electrode assembly comprising a positive electrode plate comprising a positive electrode coating portion on which a positive electrode active material is coated and a positive electrode non-coating portion on which the positive electrode active material is not coated; a negative electrode plate comprising a negative electrode coating portion on which a negative electrode active material is coated and a negative electrode non-coating portion on which the negative electrode active material is not coated; and a separator interposed between the positive and the negative electrode plates, wherein the separator comprises a substrate and a coating layer disposed on at least one surface of the substrate, wherein the coating layer comprises organic particles and inorganic particles, wherein an amount of the organic particles is in the range from 1.5 to 5 wt. % related to a total weight of the organic particles and the inorganic particles in the coating layer, and wherein the positive electrode active material is selected from lithium transition metal composite oxides including nickel (Ni), cobalt (Co) and manganese (Mn) as transition metals. Preferably, the content of nickel is at least 83 mol % based on all transition metals.

Preferred embodiments of the separator are configured as described above. In some embodiments, the positive electrode non-coating portion and the negative electrode non-coating portion may each have a length in a width direction of the electrode assembly that corresponds to the width of the electrode assembly as defined above. In some embodiments, the lithium-ion secondary battery further comprises a positive current collector electrically connected to the positive electrode non-coating portion at a connection region or weld of the positive electrode non-coating portion; and a negative current collector electrically connected to the negative electrode non-coating portion at a connection region or weld of the negative electrode non-coating portion, wherein the connection regions or welds each have a length corresponding to 70% or less of the length of the positive or negative electrode non-coating portion in a direction perpendicular to the longitudinal direction of the electrode assembly, and wherein the length of the positive current collector and the length of the negative current collector corresponds to the length of the respective connection portion or weld (i.e., 70% or less of the length of the non-coating portions), as described above

Based on the form of the electrode assembly and based on the structure or the form of a battery case, a lithium-ion secondary battery may be classified as a cylindrical-type battery, a prismatic-type battery or a pouch-shaped battery. The present disclosure is preferably applicable to the prismatic-type battery. Thus, the lithium-ion secondary battery according to the embodiments of the present disclosure is preferably a prismatic-type lithium-ion secondary battery.

Although the invention has been described above with regard to its preferred embodiments, which represent the best mode for carrying out the invention, it is understood that various changes as would be obvious to one of ordinary skill in this art can be made without departing from the scope of the disclosure, which is set forth in the appended claims.

1. An electrode assembly comprising:
a positive electrode plate comprising a positive electrode coating portion on which a positive electrode active material is coated and a positive electrode non-coating portion on which the positive electrode active material is not coated;
a negative electrode plate comprising a negative electrode coating portion on which a negative electrode active material is coated and a negative electrode non-coating portion on which the negative electrode active material is not coated; and
a separator interposed between the positive and the negative electrode plate; wherein:
the separator comprises a substrate and a coating layer disposed on at least one surface of the substrate,
the coating layer comprises organic particles and inorganic particles, and
an amount of the organic particles is in the range from 1.5 to 5 wt. % related to a total weight of the organic particles and the inorganic particles in the coating layer.

2. Electrode assembly according to claim 1, wherein the positive electrode non-coating portion and the negative electrode non-coating portion each have a length in a width direction of the electrode assembly that corresponds to the width of the electrode assembly.

3. Electrode assembly according to claim 1, wherein the positive electrode non-coating portion and the negative electrode non-coating portion are exposed from opposite sides of the electrode assembly.

4. Electrode assembly according to claim 1, wherein the electrode assembly includes a structure in which the positive electrode plate, the separator, and the negative electrode plate are stacked.

5. Electrode assembly according to claim 1, wherein the organic particles comprise at least one selected from the group consisting of polystyrenes, poly(vinyl alcohol), polyacrylic acid, polyacrylamides and polyacrylates.

6. Electrode assembly according to claim 1, wherein the organic particles have a particle diameter that is 2 to 30 times the particle diameter of the inorganic particles.

7. Electrode assembly according to claim 1, wherein the inorganic particles comprise at least one selected from the group consisting of boehmite, Al₂O₃, Al(OH)₃, Al(NO₃)₃, BN, BaSO₄, MgO, SiO₂, TiO₂, BaTiO₃ and ceramic particles.

8. Electrode assembly according to claim 1, wherein the separator has a thermal shrinkage (%) of about 5% or less at a temperature of 150° C.

9. Electrode assembly according to claim 1, wherein a coverage area of the organic particles on a surface of the coating layer is in the range of 1.5% to 5% with respect to a total surface area of the coating layer.

10. Electrode assembly according to claim 1, wherein the positive electrode active material is selected from a lithium transition metal composite oxide including nickel (Ni), cobalt (Co) and manganese (Mn) as transition metals, and wherein the content of nickel is at least 83 mol % based on all transition metals.

11. An electrochemical cell, comprising:
an electrode assembly comprising a positive electrode plate comprising a positive electrode coating portion on which a positive electrode active material is coated and a positive electrode non-coating portion on which the positive electrode active material is not coated;
a negative electrode plate comprising a negative electrode coating portion on which a negative electrode active material is coated and a negative electrode non-coating portion on which the negative electrode active material is not coated; and
a separator interposed between the positive and the negative electrode plates,
wherein:
the separator comprises a substrate and a coating layer disposed on at least one surface of the substrate,
the coating layer comprises organic particles and inorganic particles, and
an amount of the organic particles is in the range from 1.5 to 5 wt. % related to a total weight of the organic particles and the inorganic particles in the coating layer.

12. Electrochemical cell according to claim 11, wherein the positive electrode non-coating portion and the negative electrode non-coating portion each have a length in a width direction of the electrode assembly that corresponds to the width of the electrode assembly.

13. Electrochemical cell according to claim 11, further comprising:
a positive current collector electrically connected to the positive electrode non-coating portion at a connection region of the positive electrode non-coating portion; and
a negative current collector electrically connected to the negative electrode non-coating portion at a connection region of the negative electrode non-coating portion,
wherein the connection regions of the positive and the negative electrode non-coating portion each have a length in a width direction of the electrode assembly that corresponds to 70% or less of the length of the positive and negative electrode non-coating portions, respectively.

14. Electrochemical cell according to claim 11, wherein a length of the positive current collector and a length of the negative current collector corresponds to the length of the connection region of the positive and the negative electrode non-coating portion, respectively.

15. Electrochemical cell according to claim 11, wherein said connecting regions of the positive electrode non-coating portion and the negative electrode non-coating portion are in a plane parallel to a stacking plane of the positive and the negative electrode plates in the cell.

16. Electrochemical cell according to claim 11, wherein the electrochemical cell is a lithium-ion secondary battery.

17. Electrochemical cell according to claim 11, wherein the electrochemical cell is of a prismatic-type cell.

18. Lithium-ion secondary battery comprising:
an electrode assembly comprising a positive electrode plate comprising a positive electrode coating portion on which a positive electrode active material is coated and a positive electrode non-coating portion on which the positive electrode active material is not coated;
a negative electrode plate comprising a negative electrode coating portion on which a negative electrode active material is coated and a negative electrode non-coating portion on which the negative electrode active material is not coated; and
a separator interposed between the positive and the negative electrode plates,
wherein:
the separator comprises a substrate and a coating layer disposed on at least one surface of the substrate,
the coating layer comprises organic particles and inorganic particles,
an amount of the organic particles is in the range from 1.5 to 5 wt. % related to a total weight of the organic particles and the inorganic particles in the coating layer, and
the positive electrode active material is selected from lithium transition metal composite oxides including nickel (Ni), cobalt (Co) and manganese (Mn) as transition metals.

19. Lithium-ion secondary battery according to claim 18, wherein the positive electrode non-coating portion and the negative electrode non-coating portion each have a length in a width direction of the electrode assembly that corresponds to the width of the electrode assembly.

20. Lithium-ion secondary battery according to claim 18, wherein the content of nickel in the lithium transition metal composite oxide is at least 83 mol % based on all transition metals.
